(19) United States
(12) Patent Application Publication
(10) Pub. No.: US 2005/0066015 A1
(43) Pub. Date: Mar. 24, 2005

(54) Method and system for automated validation, scripting, dissemination and installation of software

(76) Inventors: Shree A. Dandekar, Austin, TX (US); Shannon C. Boesch, Austin, TX (US); David A. Butts, Austin, TX (US)

Correspondence Address: HAMILTON & TERRILE, LLP, P.O. BOX 203518, AUSTIN, TX, 78720, US

(21) Appl. No.: 10/657,989

(22) Filed: Sep. 9, 2003

(51) Int. Cl. G06F 15/177

(52) U.S. Cl. 709/220

(57) ABSTRACT

An automated system for validation, scripting, dissemination and installation of software on information handling systems. Operation of the system is triggered by the submission of a software package from a third party. The automated system instantly scans the software package for viruses prior to distributing the software to internal systems in an automated build-to-order manufacturing system. The software package is then processed to verify compliance in accordance with a predefined set of software rules. Appropriate messages are automatically generated upon detection of a compliance failure. The software package is then automatically disassembled and repackaged to integrate it directly into existing management applications within the build-to-order manufacturing system. Thereafter, factory scripts are generated and the software is disseminated to file servers for automatic configuration, execution and validation of factory test images. The method and apparatus of the present invention reduces human error and significantly reduces the time required to configure and execute factory image testing. In addition, it provides centralized audit-trailing of all actions associated with the specific software package received from a third party.

### BACKGROUND OF THE INVENTION

1. Field of the Invention

The present invention relates in general to the field of information handling systems and, more particularly, to a method and system for automated validation, scripting, dissemination and installation of software on information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In recent years, there has been an increase in the number of information handling systems that are manufactured based on a “build to order” process that allows a customer to specify specific hardware and software options. In general, prior art “build to order” systems require a large number of disjoint, manual processes that must take place for a manufacturer to successfully validate and transform third-party vendor software packages into “factory installable bits.” This not only increases the probability of human-induced error, but dramatically increases the time required to deliver validated, installable software images to the factory environment. In view of the foregoing, there is a need for an automated system for receiving software and generating validated, “factory-installable bits” without direct human interaction. Such a system is provided by the present invention, as described hereinbelow.

### SUMMARY OF THE INVENTION

The present invention overcomes the shortcomings of the prior art by providing an automated system for validation, scripting, dissemination and installation of software on information handling systems. In one embodiment of the invention, operation of the system is triggered by the submission of a software package from a third party. The automated system instantly scans the software package for viruses prior to distributing the software to internal systems in an automated build-to-order manufacturing system. The software package is then processed to verify compliance in accordance with a predefined set of software rules. If this compliance verification step indicates that any of the parameters of the software are not in accordance with the predefined rules, the third party is automatically notified of the compliance failure and is provided with specific details regarding the nature of the compliance failure. The software package is then automatically disassembled and repackaged to integrate it directly into existing management applications within the build-to-order manufacturing system. Thereafter, factory scripts are generated and the software is disseminated to file servers for automatic configuration, execution and validation of factory test images.

The method and apparatus of the present invention overcomes the shortcomings of the prior art by removing all human interaction from the build process once the third party software has been delivered. It further reduces human error and the time that would be necessary to correct such errors. Moreover, it reduces the inherent lag time between individual steps and the workflow of the build-to-order system. It significantly reduces the time required to configure and execute factory image testing and provides centralized audit-trailing of all actions associated with the specific software package received from a third party.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of an automated build-to-order system for installing software on an information handling system.

FIG. 2 is a system block diagram of an information handling system.

FIG. 3 is an illustration of an embodiment of an automated system for validating, transforming and integrating software for installation on an information handling system.

FIG. 4 is a flowchart illustration of the processing steps for implementing the method for validating, transforming, scripting and integrating software in accordance with the present invention.

### DETAILED DESCRIPTION

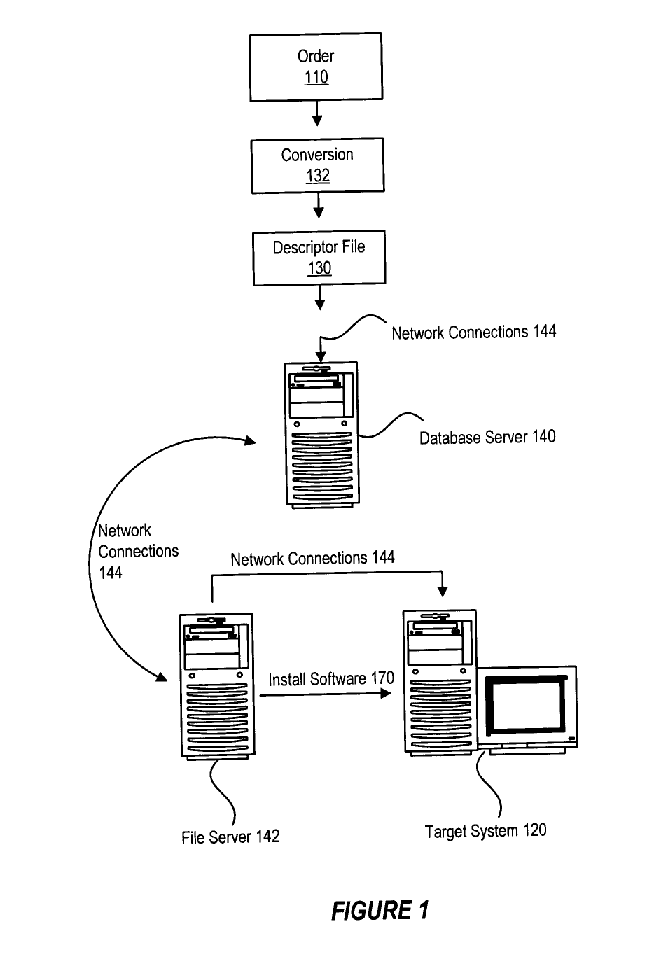

FIG. 1 is a schematic diagram of a software installation system 100 at an information handling system manufacturing site. In operation, an order 110 is placed to purchase a target information handling system 120. The target information handling system 120 to be manufactured contains a plurality of hardware and software components. For instance, target information handling system 120 might include a certain brand of hard drive, a particular type of monitor, a certain brand of processor, and software. The software may include a particular version of an operating system along with all appropriate driver software and other application software along with appropriate software bug fixes. Before target information handling system 120 is shipped to the customer, the plurality of components are installed and tested. Such software installation and testing advantageously ensures a reliable, working information handling system which is ready to operate when received by a customer.

Because different families of information handling systems and different individual computer components require different software installation, it is necessary to determine which software to install on a target information handling system 120. A descriptor file 130 is provided by converting an order 110, which corresponds to a desired information handling system having desired components, into a computer readable format via conversion module 132.

Component descriptors are computer readable descriptions of the components of target information handling system 120 which components are defined by the order 110. In a preferred embodiment, the component descriptors are included in a descriptor file called a system descriptor record which is a computer readable file containing a listing of the components, both hardware and software, to be installed onto target information handling system 120. Having read the plurality of component descriptors, database server 140 provides a plurality of software components corresponding to the component descriptors to file server 142 over network connection 144. Network connections 144 may be any network connection well-known in the art, such as a local area network, an intranet, or the internet. The information contained in database server 140 is often updated such that the database contains a new factory build environment. The software is then installed on the target information handling system 120. The software installation is controlled by a software installation management server, discussed in greater detail below, that is operable to control the installation of the operating system and other software packages specified by a customer.

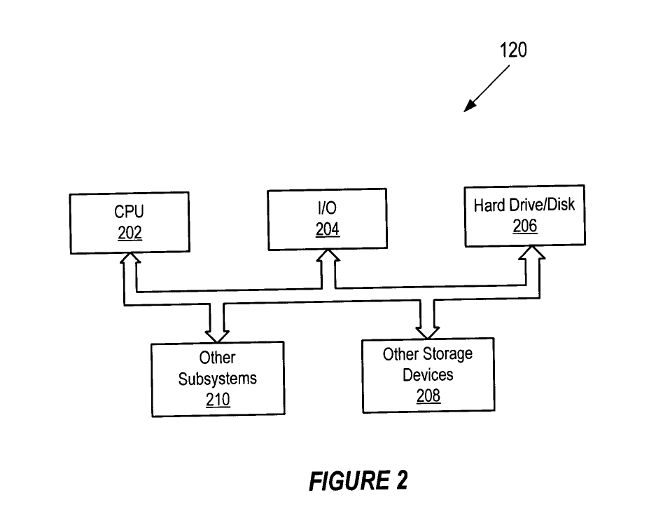

FIG. 2 is a generalized illustration of an information handling system, such as the target information handling system 120 illustrated in FIG. 1. The information handling system includes a processor 202, input/output (I/O) devices 204, such as a display, a keyboard, a mouse, and associated controllers, a hard disk drive 206, and other storage devices 208, such as a floppy disk and drive and other memory devices, and various other subsystems 210, all interconnected via one or more buses 212. The software that is installed according to the versioning methodology is installed onto hard disk drive 206. Alternately, the software may be installed onto any appropriate non-volatile memory. The non-volatile memory may also store the information relating to which factory build environment was used to install the software. Accessing this information enables a user to have additional systems corresponding to a particular factory build environment to be built.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

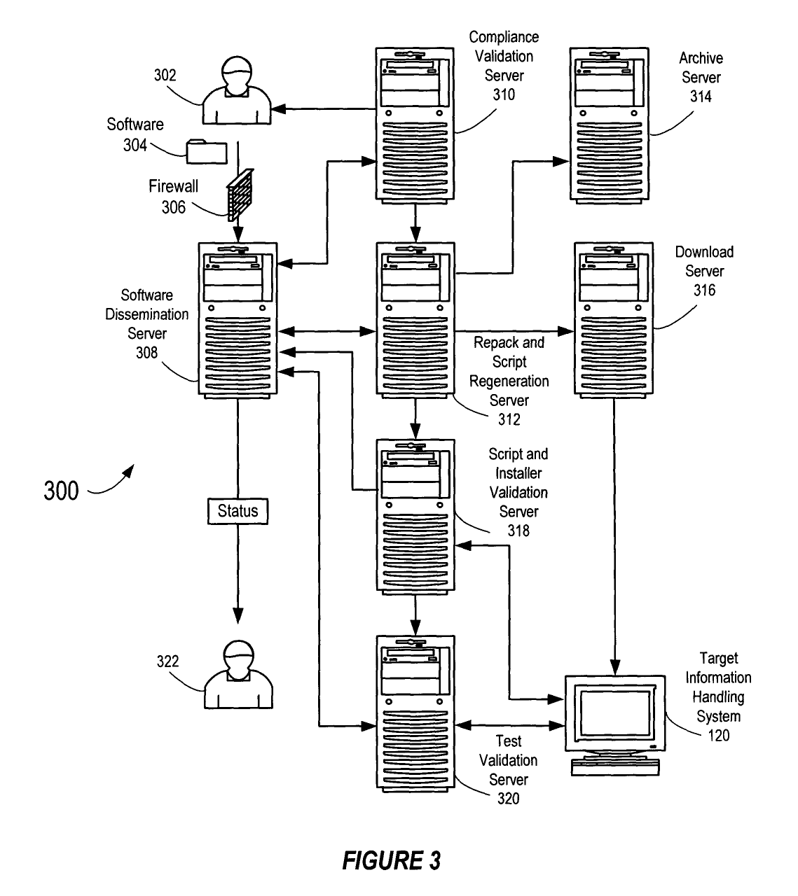

FIG. 3 is an illustration of the components of the automated system for converting, optimizing and disseminating software in accordance with the present invention. A third party 302 delivers a software package 304 to the system via a firewall 306. If the software package 304 is verified and authorized to pass through the firewall, it is received by a software dissemination server 308. The software dissemination server 308 scans the software package for viruses and transfers the file to a compliance validation server 310 which verifies that the software package complies with a predetermined set of rules required by the build-to-order automated manufacturing system. Examples of such rules include, but are not limited to, naming conventions, length of directory path names, “hidden only” attributes, and “read only” attributes. If the compliance validation server 310 determines that the software package 304 contains errors or that it fails to comply with the predetermined rules, an e-mail notice is sent to the third party 302 to notify the third party about the specific errors and non-compliance parameters that were detected. If, however, the compliance validation server 310 determines that the software package is in compliance, then a compliance validation notice is sent to the repack and script regeneration server 312 which then downloads the software package from the software dissemination server 308.

The repack and script regeneration server 312 disassembles the software package 304 and repackages the software to integrate it directly into existing management applications. In this process, the server 312 generates factory scripts for each package to produce “factory installable bits.” These “factory installable bits” are then transferred to the download server 316. A copy of the software package 304 is also transferred to an archive server 314. The repack and script regeneration server 312 then generates a signal authorizing the script and installation validation server 318 to generate appropriate commands to control downloading of software by the target information handling system 120. The results of the installation are monitored by the server 318 and results are communicated to the software dissemination server 308 while the actual software images are downloaded by the download server 316 onto the hard drive or other storage media of the target information handling system 120.

After the software images have been downloaded to the target information handling system 120, tests are performed by a test validation server 320 which performs a series of tests to confirm that the software images have been properly installed and that the operational integrity of the software package is satisfactory. The results of the test performed by the test validation server 320 are communicated to the software dissemination server 308 which is operable to generate a status report for viewing by a program manager 322.

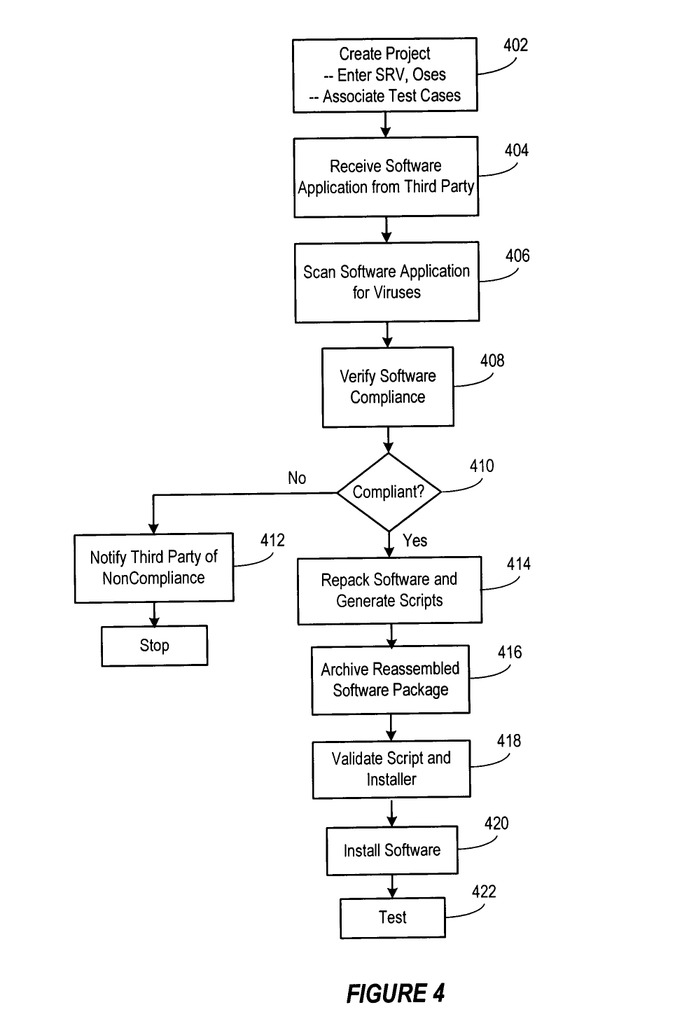

FIG. 4 is a flowchart illustration of the processing steps implemented by the system of the present invention. In step 402, a project is defined by various parameters, such as the software part number (SRV) and operating systems (OSes) and the associated test cases for a particular software package. In step 404, a software application is received from a third party. In step 406, the software package received from the third party is scanned for viruses. In step 408, the software package is analyzed to confirm that it complies with a predetermined set of rules to ensure error-free integration into the factory manufacturing system. In step 410, a test is conducted to determine if any compliance errors have been detected. If the result of the test conducted in step 410 indicates that the software package is not compliant, the third party is notified in step 412 of the specific non-compliance factors. If, however, the test conducted in step 410 indicates that the software is compliant, processing proceeds to step 414 where the software package is disassembled, separated, then reassembled into one or more usable packages for integration into the factory manufacturing environment and factory scripts are generated for each package to derive “factory installable bits.” In step 416, the reassembled software package is archived in archive server 314. In step 418, the factory script is validated and installation of the software package is authorized. In step 420, software images are downloaded to the target information handling system and in step 422 the installed software is tested.

Testing of the software can be accomplished using the system and methods described in co-pending applications Ser. No. 10/267,513, filed on Oct. 9, 2002, entitled “Method and System for Test Management,” Ser. No. 09/564,054, filed on May 3, 2000, entitled “Automated Test System in a Factory Install Environment” and Ser. No. 10/614,762, filed on Jul. 7, 2003, entitled “Method and System for Information Handling System Automated and Distributed Test.” Each of the aforementioned patent applications is hereby incorporated by reference herein for all purposes.

### Other Embodiments

Other embodiments are within the following claims.

For example, the above-discussed embodiments include software modules that perform certain tasks. The software modules discussed may include script, batch, or other executable files. The software modules may be stored on a machine-readable or computer-readable storage medium such as a disk drive. Storage devices used for storing software modules may be magnetic floppy disks, hard disks, or optical discs such as CD-ROMs or CD-Rs, for example. A storage device used for storing firmware or hardware modules may also include a semiconductor-based memory, which may be permanently, removably or remotely coupled to a microprocessor memory system. Thus, the modules may be stored within a computer system memory to configure the computer system to perform the functions of the module. Other new and various types of computer-readable storage media may be used to store the modules discussed herein. Consequently, the invention is intended to be limited only by the spirit and scope of the appended claims, giving full cognizance to equivalents in all respects.

Although the present invention has been described in detail, it should be understood that various changes, substitutions and alterations can be made hereto without departing from the spirit and scope of the invention as defined by the appended claims.

1. A system for automated dissemination of software to an information handling system, comprising:
a distribution server operable to receive a software file;
a repack and script regeneration server operably connected to said distribution server, said repack and script server operable to disassemble said software file and repackage said software file with scripts for automatically controlling the transfer of said software files;
a script validation server operably coupled to said repack and script regeneration server and said distribution server, said script validation server operable to generate commands to automatically control the downloading of software images of said software file to a target information handling system; and
a download server operable to transfer said software to a target information handling system after verification that said software file complies with a set of predetermined parameters.

2. The system of claim 1, further comprising a compliance server operably connected to said distribution server, said compliance server being operable to perform compliance verification to confirm that said software file complies with said set of predetermined parameters.

3. The system of claim 2 wherein the compliance server is operable to automatically generate a non-compliance notice message upon detection that said software files does not comply with said predetermined set of parameters.

4. The system of claim 1, wherein said distribution server is operable to scan said software file for viruses.

5. The system of claim 1, further comprising a test control server operable to confirm the download of said software file to said target information handling system and to verify proper operation of said software file on said target information handling system.

6. The system of claim 1 wherein said distribution server is operable to notify a manager regarding the status of the software file within the software distribution system.

7. The system of claim 1 further comprising an archive server, wherein said repack and script regeneration server is operable to transfer copies of said repackaged software file to said archive server for storage thereon.

8. A method for automated dissemination of software to an information handling system, comprising:
receiving a software file;
disassembling said software file and repackaging said software file with scripts for automatically controlling the transfer of said software file;
generating commands to control the automatic downloading of software images of said software file to a target information handling system; and
transferring said software to a target information handling system after verification that said software file complies with a set of predetermined parameters.

9. The method of claim 8, further comprising the step of performing compliance verification to confirm that said software file complies with said set of predetermined parameters.

10. The method of claim 9, further comprising the step of generating a non-compliance notice message upon detection that said software files does not comply with said predetermined set of parameters.

11. The method of claim 8, further comprising the step of scanning said software file for viruses.

12. The method of claim 8, further comprising the steps of confirming the download of said software file to said target information handling system and verifying proper operation of said software file on said target information handling system.

13. The method of claim 8, further comprising the step of notifying a manager regarding the status of the software file within the software distribution system.

14. The method of claim 8, further comprising the step of transferring copies of said repackaged software file to an archive server for storage thereon.

15. An information handling system, comprising:
a data processor;
data storage having a software file stored thereon, said software file being transferred to said data storage by an automated software dissemination system comprising;
a distribution server operable to receive a software file;
a repack and script regeneration server operably connected to said distribution server, said repack and script server operable to disassemble said software file and repackage said software file with scripts for automatically controlling the transfer of said software files;
a script validation server operably coupled to said repack and script regeneration server and said distribution server, said script validation server operable to generate commands to automatically control the downloading of software images of said software file to said information handling system; and
a download server operable to transfer said software to said information handling system after verification that said software file complies with a set of predetermined parameters.

16. The system of claim 15, further comprising a compliance server operably connected to said distribution server, said compliance server being operable to perform compliance verification to confirm that said software file complies with said set of predetermined parameters.

17. The system of claim 16 wherein the compliance server is operable to automatically generate a non-compliance notice message upon detection that said software files does not comply with said predetermined set of parameters.

18. The system of claim 15, wherein said distribution server is operable to scan said software file for viruses.

19. The system of claim 15, further comprising a test control server operable to confirm the download of said software file to said information handling system and to verify proper operation of said software file on said target information handling system.

20. The system of claim 15 wherein said distribution server is operable to notify a manager regarding the status of the software file within the software distribution system.
